(19) United States
(12) Patent Application Publication
(10) Pub. No.: US 2026/0350310 A1
(43) Pub. Date: Nov. 5, 2026

(54) PRESENTATION DEVICE, PRESENTATION METHOD AND PRESENTATION PROGRAM

(71) Applicant: NIPPON TELEGRAPH AND TELEPHONE CORPORATION, Tokyo (JP)

(72) Inventors: Ryohei SAIJO, Tokyo (JP); Iwaki TOSHIMA, Tokyo (JP); Shohei MATSUO, Tokyo (JP); Ai NAKANE, Tokyo (JP)

(73) Assignee: NIPPON TELEGRAPH AND TELEPHONE CORPORATION, Tokyo (JP)

(21) Appl. No.: 19/123,689

(22) PCT Filed: Oct. 27, 2022
(86) PCT No.: PCT/JP2022/040253

§ 371 Date: Apr. 23, 2025

(51) Int. Cl. G06F 40/268; G06F 40/253; G06F 40/279; G06F 40/35

(52) U.S. Cl. CPC G06F 40/268; G06F 40/253; G06F 40/279; G06F 40/35

(57) ABSTRACT

In a presentation device (10), a storage unit (14) stores a risk expression dictionary (14a) which is information relating to a risk of language trouble for each word constituting a dialog sentence. A calculation unit (15b) refers to the risk expression dictionary (14a) and calculates a risk value indicating a magnitude of the risk of each word constituting the input dialog sentence.

### TECHNICAL FIELD

The present invention relates to a presentation device, a presentation method, and a presentation program.

### BACKGROUND ART

In communication through language, expressions that may impede mutual respect and understanding such as ambiguous expressions, high-handed expressions, and expressions based on fixed ideas are sometimes used. In the past, a system that immediately transcribes content of utterances so that a user can easily look back on the used expressions after communication has been proposed (see PTL 1).

### CITATION LIST

### Patent Literature

[PTL 1] Japanese Patent Application Publication No. 2020-140629

### SUMMARY OF INVENTION

### Technical Problem

However, according to the related art, it is difficult to quantitatively analyze the risk implied by the used expressions in communication through language.

The present invention was contrived in view of the above, and an object thereof is to quantitatively analyze the risk implied by the used expressions in communication through language.

### Solution to Problem

In order to solve the above problem and achieve the object, according to the present invention, there is provided a presentation device including: a storage unit configured to store information relating to a risk of language trouble for each word constituting a dialog sentence; and a calculation unit configured to refer to the storage unit and calculate a risk value indicating a magnitude of the risk of each word constituting the input dialog sentence.

### Advantageous Effects of Invention

According to the present invention, it is possible to quantitatively analyze the risk implied by used expressions in communication through language.

### BRIEF DESCRIPTION OF DRAWINGS

FIG. 1 is a schematic diagram illustrating a schematic configuration of a presentation device according to the present embodiment.

FIG. 2 is a diagram illustrating a data configuration of a risk expression dictionary.

FIG. 3 is a diagram illustrating a risk expression dictionary.

FIG. 4 is a diagram illustrating a data configuration of a relationship DB.

FIG. 5 is a diagram illustrating a data configuration of a social attribute DB.

FIG. 6 is a diagram illustrating a data configuration of a personal characteristic DB.

FIG. 7 is a diagram illustrating a data configuration of a communication history DB.

FIG. 8 is a diagram illustrating processing of a calculation unit.

FIG. 9 is a diagram illustrating an example of screen display of presentation processing results.

FIG. 10 is a flowchart illustrating a presentation processing procedure.

FIG. 11 is a diagram illustrating an example of a computer that executes a presentation program.

### DESCRIPTION OF EMBODIMENTS

An embodiment of the present invention will be described in detail below with reference to the accompanying drawings.

Meanwhile, the present invention is not limited to the embodiment. In addition, the same constituent elements are denoted by the same reference numerals in the description of the drawings.

### Configuration of Presentation Device

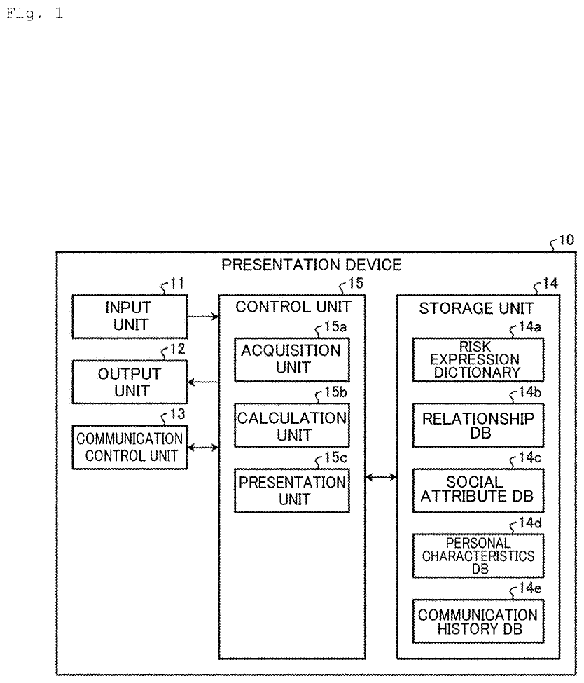

FIG. 1 is a schematic diagram illustrating a schematic configuration of a presentation device according to the present embodiment. As illustrated in FIG. 1, a presentation device 10 of the present embodiment is realized by a general-purpose computer such as a personal computer, and includes an input unit 11, an output unit 12, a communication control unit 13, a storage unit 14, and a control unit 15.

The input unit 11 is realized using an input device such as a keyboard, a mouse, a camera, or a microphone, and inputs various types of instruction information such as the start of processing to the control unit 15 in response to an input operation performed by an operator. The output unit 12 is realized by a display device such as a liquid crystal display, a printing device such as a printer, or the like. For example, the output unit 12 displays the results of presentation processing to be described later.

The communication control unit 13 is implemented by a network interface card (NIC) or the like and controls communication between an external device and the control unit 15 through a telecommunication line such as a local area network (LAN) or the Internet. For example, the communication control unit 13 controls communication between the control unit 15 and an external management device that manages various types of information, and the like.

The storage unit 14 is realized by a semiconductor memory element such as a random access memory (RAM) or a flash memory, or a storage device such as a hard disk or an optical disc. In the storage unit 14, a processing program for operating the presentation device 10, data used during execution of the processing program, and the like are stored in advance, or are temporarily stored each time processing is performed. Meanwhile, the storage unit 14 may also be configured to communicate with the control unit 15 through the communication control unit 13.

In the present embodiment, the storage unit 14 stores a risk expression dictionary 14a. The risk expression dictionary 14a includes information relating to the risk of language trouble for each word constituting a dialog sentence. Specifically, the risk expression dictionary 14a includes information relating to the risk of any one or more of the part of speech of each word, the number of meanings indicated by each word, or the ambiguity of the meaning indicated by each word. This information is collected through the input unit 11 or from a management device or the like that manages various types of information prior to presentation processing to be described later or during the presentation processing, and stored in the storage unit 14.

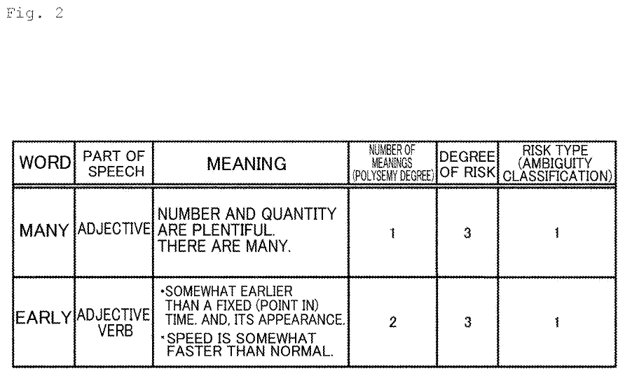

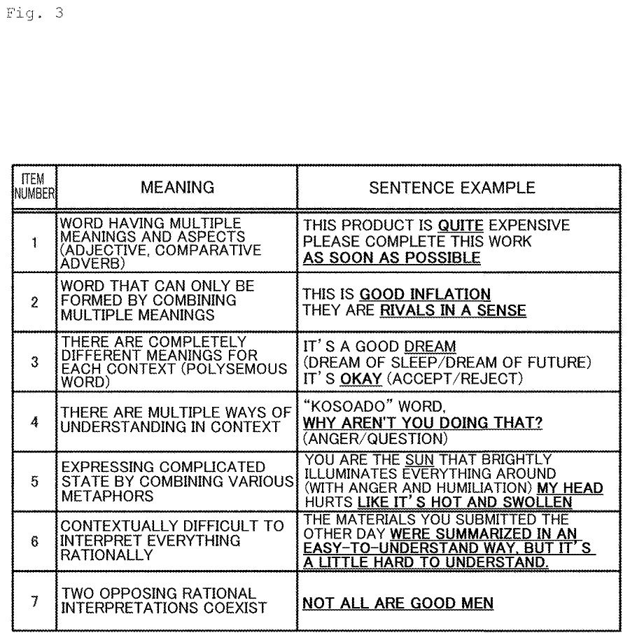

Here, FIG. 2 is a diagram illustrating a data configuration of a risk expression dictionary, In addition, FIG. 3 is a diagram illustrating a risk expression dictionary. First, as illustrated in FIG. 2, the risk expression dictionary 14a includes information items such as the part of speech, the meaning, the number of meanings, the degree of risk, and the risk type for each word.

The number of meanings is the number of different meanings for the same word. Additionally, the number of homophones may be added. The degree of risk is, for example, a value set by a user for each word in consideration of the part of speech, risk type, and relation with work, and the like. Alternatively, a value based on a classification table of ambiguous words specified in advance or the like may be applied to the degree of risk.

The risk type is, for example, a value in the range of 1 to 7 indicating each class of ambiguity classification. Here, FIG. 3 illustrates the classification of seven classes of ambiguity. For example, risk type=1 is set for a word having a plurality of meanings.

Meanwhile, the risk expression dictionary 14a may include information items that change dynamically during use, such as the importance of each word in a sentence. For example, it may be possible to individually set a word with a high risk value calculated in the presentation processing to be described later so that the risk value is calculated low in a case where the importance is not high.

In addition, the risk expression dictionary 14a is not limited to information items for each word, and may be information items for each expression of a group which is composed of a plurality of words. Expressions in this case may include verbal expressions of facial expressions, and the like.

In addition, the storage unit 14 stores a relationship data base (DB) 14b, a social attribute DB 14c, a personal characteristic DB 14d, a communication history DB 14e, and the like. The relationship data base (DB) 14b includes information relating to a relationship between speakers. The social attribute DB 14c includes information indicating the social attribute of a speaker and an interlocutor. The personal characteristic DB 14d includes information indicating the characteristics of a speaker related to an utterance. The communication history DB 14e includes a dialog history. This information is collected through the input unit 11 or from a management device or the like that manages various types of information prior to presentation processing to be described later or during the presentation processing, and stored in the storage unit 14.

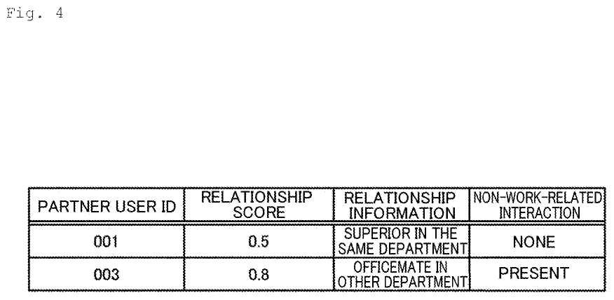

Here, FIG. 4 is a diagram illustrating a data configuration of a relationship DB. As illustrated in FIG. 4, the relationship DB 14b includes, for each user, a relationship score, relationship information, non-work-related interaction, and the like as information items indicating the relationship with a specific partner user. FIG. 4 illustrates the relationship DB 14b for a user whose user ID is 002.

The relationship score is a value in the range of 0.0 to 1.0, with values closer to 1 indicating a closer relationship and values closer to 0 indicating a more distant relationship. For example, since a partner user with whom one has a high frequency of dialog is in a close relationship, the relationship score may be calculated using the dialog frequency in the communication history DB 14e to be described later. Alternatively, by referring to the positions in the social attribute DB 14c to be described later, the relationship score may be set to 0.5 if the positions are the same, and 0.1 if the positions are far apart, such as the president and a regular employee. Alternatively, the relationship score may be calculated comprehensively by referring to information items in the communication history DB 14e, the social attribute DB 14c, and the personal characteristic DB 14d which will be described later, or may be calculated from compatibility using the company's corporate culture, the evaluation value of the individual's personality such as Big5, and the like.

The relationship information indicates a business relationship with a specific partner user from the user's perspective such as, for example, a relationship with a supervisor in the same department. The non-work-related interaction indicates the presence or absence of interaction outside of work.

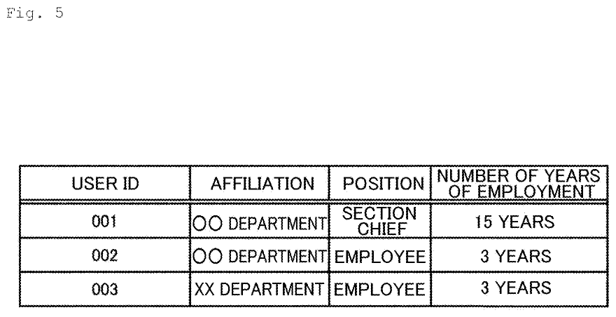

FIG. 5 is a diagram illustrating a data configuration of a social attribute DB. As illustrated in FIG. 5, the social attribute DB 14c includes affiliation, position, the number of years of employment, and the like as information items indicating social attributes of a speaker and an interlocutor, that is, social positions. The social attribute DB 14c is set for each topic or scene of a dialog. FIG. 5 illustrates an example of the social attribute DB 14c in business topics.

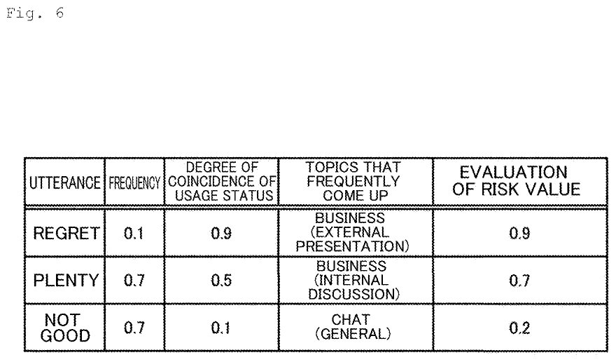

FIG. 6 is a diagram illustrating a data configuration of a personal characteristic DB. As illustrated in FIG. 6, the personal characteristic DB 14d includes, for each user, frequency, the degree of coincidence of usage status, topics that frequently come up, evaluation of risk value, and the like as information items indicating the characteristics of a speaker with respect to each utterance.

The frequency is a value in the range of 0.0 to 1.0 indicating the frequency of occurrence of the utterance. The degree of coincidence of usage status is a value in the range of 0.0 to 1.0 indicating the degree of coincidence of the topic in which the utterance occurs. The evaluation of risk value is a value in the range of 0.0 to 1.0 indicating the user's self-evaluation of the history of risk values calculated for the word, and as the value increases, the evaluation that the risk value is appropriate becomes higher.

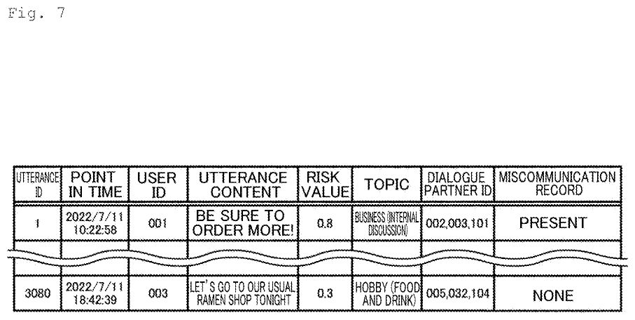

FIG. 7 is a diagram illustrating a data configuration of a communication history DB. As illustrated in FIG. 7, the communication history DB 14e indicates a dialog history, and includes, for each utterance, information items such as an utterance ID, a user ID, a point in time, utterance content, a risk value, a topic, a dialog partner ID, and a miscommunication record.

The risk value is a risk value calculated in the past by presentation processing to be described later. The topic is a label indicating the outline of the conversation in which the utterance has been made, which causes an appropriate social attribute DB 14c to be selected. The miscommunication record indicates whether there is a record of trouble caused by the utterance.

Meanwhile, the communication history DB 14e may include non-verbal communication expressions such as facial expressions based on video data and the like.

FIG. 1 will be described again. The control unit 15 is implemented by using a central processing unit (CPU) or the like, and executes a processing program stored in a memory. Thereby, as illustrated in FIG. 1, the control unit 15 functions as an acquisition unit 15a, a calculation unit 15b, and a presentation unit 15c, and executes the presentation processing. Meanwhile, each or some of these function units may be mounted on a different piece of hardware. In addition, the control unit 15 may include other functional units.

The acquisition unit 15a acquires words constituting a dialog sentence to be processed. Specifically, the acquisition unit 15a accepts an input of a dialog sentence to be processed through the input unit 11 or the communication control unit 13, performs morphological analysis, and extracts words constituting the dialog sentence.

Meanwhile, the acquisition unit 15a may cause the storage unit 14 to store words constituting the dialog sentence acquired prior to the presentation processing to be described later. Alternatively, the acquisition unit 15a may immediately transfer this information to the calculation unit 15b.

The calculation unit 15b refers to the risk expression dictionary 14a of the storage unit 14 and calculates a risk value indicating the magnitude of risk of each word constituting the input dialog sentence. Here, the risk value indicates an estimation value of the magnitude of risk of language trouble, that is, miscommunication occurrence, for each word appearing in a sentence or for the entire sentence. The calculation unit 15b calculates a risk value using a risk variable derived from information relating to risk included in the risk expression dictionary 14a.

Here, the risk variable is derived on the basis of, for example, the part of speech or the degree of risk of the word. Alternatively, the risk variable is derived on the basis of the number of meanings of the word. Alternatively, the risk variable is derived on the basis of the risk type. Meanwhile, the risk variable related to the context is not used.

In addition, the calculation unit 15b may calculate a risk value for each expression of a group which is a unit of information in the risk expression dictionary 14a and is composed of a plurality of words. Expressions in this case may include verbal expressions of facial expressions, and the like.

The calculation unit 15b calculates a risk value using the product of information relating to a plurality of risks having undergone predetermined weighting. Specifically, the calculation unit 15b calculates a risk value rᵢ of the i-th word in the sentence on the basis of the following Equation (1).

[Math. 1]

rᵢ=w₁pᵢ₁×w₂pᵢ₂×w₃pᵢ₃ (1)
Here, rᵢ: A risk value of the i-th word in the sentence
pᵢ₁: A risk variable based on the part of speech or the degree of risk of the i-th word in the sentence
Pᵢ₂: A risk variable based on the number of meanings of the i-th word in the sentence
pᵢ₃: A risk variable based on the risk type of the i-th word in the sentence
w₁ to w₃: Weight variables for adjusting the degree of influence of each risk variable

Here, the risk variable pᵢ₁ based on the part of speech or the degree of risk of the word has, for example, three levels of values from 1 to 3 with a higher value indicating higher risk. For example, in a case where the part of speech is a modifier such as an adjective or adverb, it is ambiguous and has a high risk, so it is set to 3, demonstrative words are set to 2, and other words are set to 1. Alternatively, the degree of risk may be applied as it is, or a value based on the part of speech and the value of the degree of risk may be used in combination.

In addition, the risk variable pᵢ₂ based on the number of meanings of the word, for example, may have a value registered in the risk expression dictionary 14a applied as it is, or may be a value classified into about three levels of values similarly to the risk variable pᵢ₁.

In addition, the risk variable pᵢ₂ based on the risk type of the word may be set to, for example, a value by a user who is familiar with the business situation.

In addition, the weight variables w₁ to w₃ and the risk variables pᵢ₁ to pᵢ₃ are adjusted so that the risk value 1; takes a value greater than 0.0.

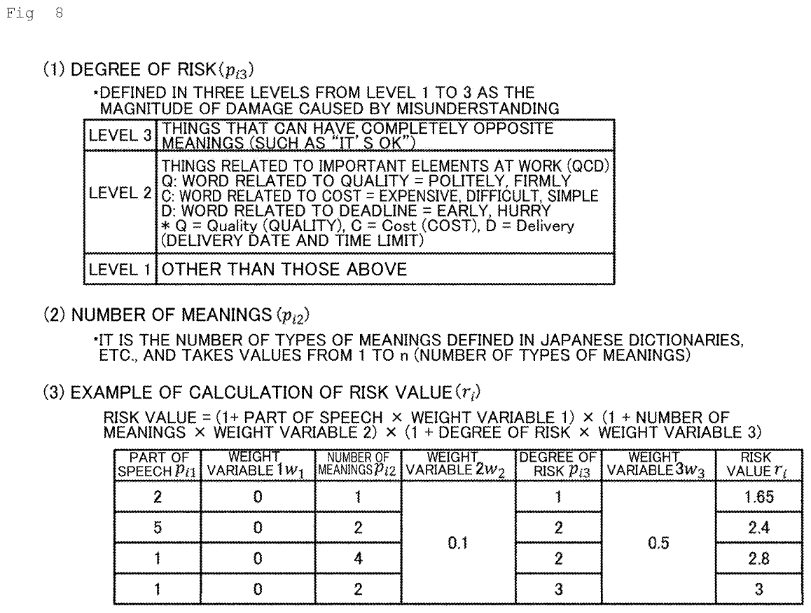

Here, FIG. 8 is a diagram illustrating processing of a calculation unit. FIG. 8(1) illustrates the degree of risk defined in three levels, levels 1 to 3, as the risk variable pᵢ₃ based on the risk type of the word. In addition, FIG. 8(2) illustrates the risk variable pᵢ₂ based on the number of meanings of the word.

FIG. 8(3) illustrates an example of calculating the risk value rᵢ using the part of speech pᵢ₁, the number of meanings pᵢ₂, and the degree of risk pᵢ₃ of the i-th word. Here, in the example shown in FIG. 8(3), the weight variable 1 (w₁) of the part of speech pᵢ₁ is set to 0, the influence of the part of speech pᵢ₁ is suppressed, and the risk value rᵢ is calculated from the number of meanings pᵢ₂ and the degree of risk pᵢ₃.

Meanwhile, in the example shown in FIG. 8(3), in order to prevent the risk value rᵢ from being set to 0, 1 is added to the part of speech pᵢ₁×weight variable 1 (w₁), the number of meanings pᵢ₂×weight variable 2 (w₂), and the degree of risk pᵢ₃×weight variable 3 (w₃), and then multiplied.

FIG. 1 will be described again. The calculation unit 15b may calculate the risk value using the sum of information relating to a plurality of risks having undergone predetermined weighting. For example, the calculation unit 15b calculates the risk value rᵢ of the i-th word in the sentence on the basis of the following Equation (2).

[Math. 2]

rᵢ=w₁pᵢ₁+w₂pᵢ₂+w₃pᵢ₃ (2)
Here, rᵢ: A risk value of the i-th word in the sentence
pᵢ₁: A risk variable based on the part of speech of the i-th word in the sentence
pᵢ₂: A risk variable based on the number of meanings of the i-th word in the sentence
pᵢ₃: A risk variable based on the risk type of the i-th word in the sentence
w₁ to w₃: Weight variables for adjusting the degree of influence of each risk variable

In this case, each of the risk variables pᵢ₁ to pᵢ₃ has a normalized value of 0.0 to 1.0, and the weight variables w₁ to w₃ have values in the range of 0.0 to 1.0. Thereby, the calculated risk value rᵢ also falls within the range of 0.0 to 1.0, making it easy to compare risk values.

The calculation unit 15b may further calculate the risk value using any one or more of information relating to the relationship between speakers, information indicating the social attribute of the speaker and the interlocutor, information indicating the characteristics of the speaker, or the dialog history. For example, the calculation unit 15b calculates the risk value by referring to any of the relationship DB 14b, the social attribute DB 14c, the personal characteristic DB 14d, or the communication history DB 14e. This makes it possible to calculate a risk value in consideration of context.

In this case, the calculation unit 15b calculates the risk value rᵢ of the i-th word in the sentence on the basis of, for example, the following Equation (3).

[Math. 3]

rᵢ=w₁pᵢ₁×w₂pᵢ₂×w₃pᵢ₃×w₄pᵢ₄×w₅pᵢ₅×w₆pᵢ₆×w₇pᵢ₇ (3)
Here, rᵢ: A risk value of the i-th word in the sentence
pᵢ₁: A risk variable based on the part of speech of the i-th word in the sentence
pᵢ₂: A risk variable based on the number of meanings of the i-th word in the sentence
Pᵢ₃: A risk variable based on the risk type of the i-th word in the sentence
Pᵢ₄: A risk variable based on a relationship between users of the i-th word in the sentence
pᵢ₅: A risk variable based on the social attribute of the i-th word in the sentence
pᵢ₆: A risk variable based on the personal characteristics of the i-th word in the sentence
pᵢ₇: A risk variable based on the dialog history of the i-th word in the sentence
w₁ to w₇: Weight variables for adjusting the degree of influence of each risk variable

Here, the risk variables pᵢ₁ to pᵢ₃ are the same as in Equation (1). In addition, the weight variables w₁ to w₇ have values in the range of 0.0 to 1.0. In addition, the weight variables w₁ to w₇ and the risk variables pᵢ₁ to pᵢ₇ are adjusted so that the calculated risk value rᵢ takes a value greater than 0.0.

The risk variable pᵢ₄ based on the relationship between users may be, for example, a value obtained by subtracting the relationship score of the relationship DB 14b from 1, or may be the product of a value obtained by subtracting the relationship score from 1, with the value as 2 if there is non-work-related interaction and as 1 if there is none. By calculating the value in this way, the risk variable pᵢ₄ has a larger value as the relationship becomes weaker, and the risk value becomes larger.

The risk variable pᵢ₅ based on the social attribute may be, for example, the difference between users in the number of years of employment in the social attribute DB 14c, or may be digitized as a larger value as the position becomes higher, and may be the difference in the digitized position between users during the dialog. By calculating the value in this way, the risk variable pᵢ₅ becomes a larger value as the difference in position within the organization such as the number of years of employment or position becomes larger, and the risk value becomes larger.

Alternatively, the product of or sum of the risk variable pᵢ₄ and the risk variable pᵢ₅ calculated as described above may be substituted as the risk variable pᵢ₄ and the risk variable pᵢ₅.

The risk variable pᵢ₆ based on the personal characteristics may be, for example, a value obtained by subtracting the degree of coincidence of the usage status of the personal characteristic DB 14d from 1, or may be the reciprocal of the degree of coincidence of the usage status. Alternatively, risk variable pᵢ₆ may be the frequency of the personal characteristic DB 14d, or may be the product of the frequency and the value obtained by subtracting the degree of coincidence of the usage status from 1.

The risk variable pᵢ₇ based on the dialog history may be, for example, the risk value of the communication history DB 14e, or may be the product of the risk value and a value obtained by digitizing the miscommunication record (2 if present and 1 if not). Alternatively, assuming that as the relationship with the work becomes deeper, the risk of discrepancy in communication becomes greater, the risk variable pᵢ₇ may be set as a value obtained by digitizing the relationship with the work of the topic or the like, so that it becomes greater as the relationship with the work. For example, confidential information related to corporate strategy is 1, general internal information is 0.5, public information relating to recreational events after work is 0.1, and the like.

Alternatively, the calculation unit 15b may calculate the risk value rᵢ of the i-th word in the sentence on the basis of the following Equation (4).

[Math. 4]

rᵢ=w₁pᵢ₁+w₂pᵢ₂+w₃pᵢ₃+w₄pᵢ₄+w₅pᵢ₅+w₆pᵢ₆+w₇pᵢ₇ (4)
Here, rᵢ: A risk value of the i-th word in the sentence
pᵢ₁: A risk variable based on the part of speech of the i-th word in the sentence
pᵢ₂: A risk variable based on the number of meanings of the i-th word in the sentence
pᵢ₃: A risk variable based on the risk type of the i-th word in the sentence
pᵢ₄: A risk variable based on a relationship between users of the i-th word in the sentence
pᵢ₅ A risk variable based on the social attribute of the i-th word in the sentence
pᵢ₆: A risk variable based on the personal characteristics of the i-th word in the sentence
pᵢ₇: A risk variable based on the dialog history of the i-th word in the sentence
w₁ to w₇: Weight variables for adjusting the degree of influence of each risk variable

Here, the risk variable pᵢ₁ to pᵢ₇ are normalized values of 0.0 to 1.0 similar to those in Equation (3), and the weight variables w₁ to w₇ are values in the range of 0.0 to 1.0.

Meanwhile, the values of the risk variables pᵢ₁ to pᵢ₇ are not limited to the above. For example, by additionally registering a predetermined information item in each piece of information (14a to 14e) in the storage unit 14, values as illustrated below may be applied.

For example, as the risk variables pᵢ₁ to pᵢ₃ using the risk expression dictionary 14a, the degree of occurrence of miscommunication caused by the word, the degree of risk when miscommunication occurs with the word, the frequency of appearance of the word in general conversation, and the like may be applied.

In addition, as the risk variable pᵢ₄ using the relationship DB 14b or the risk variable pᵢ₅ using the social attribute DB 14c, the common background between speakers, the degree of density and degree of overlap of attributes, the percentage of common recognition between speakers, the human relationship between speakers, and the like may be applied.

In addition, as the risk variable pᵢ₆ using the personal characteristic DB 14d, the speaker's background, attributes, evaluation of risk values calculated for past utterances, and the like may be applied.

In addition, as the risk variable pᵢ₇ using the communication history DB 14e, words that appear many times in the current dialog, words that appear many times in the past dialog, words for which miscommunication has occurred in the past dialog, words for which common recognition has been obtained, and the like may be applied.

Further, a method of calculating a risk value is limited to the case of using each piece of information (14a to 14e) in the storage unit 14. For example, the risk value may be calculated using the following exemplary information that can be collected during the dialog.

For example, the risk value may be calculated using a combination of the analysis results of ecological signals such as facial expressions, brain waves, and gaze, and the content of utterances in the communication history DB 14e. In addition, the evaluation value of medical or objective change in physical condition of the person concerned may be additionally applied as a risk variable.

Alternatively, the severity of trouble that has occurred after the dialog may be fed back and reflected in the degree of risk or importance in the risk expression dictionary 14a or the risk value in the communication history DB 14e. The severity of this trouble may be evaluated subjectively by the user and reflected in the degree of risk or importance in the risk expression dictionary 14a. In addition, this information may be used together.

In addition, the weight variables w₁ to w₇ are variables for adjusting the influence of each risk variable, and are set in accordance with the topic and participants of the dialog to be processed for risk value calculation. For example, in a case where there are participants who are not good at guessing the meaning of ambiguous utterances, increasing the values of the weight variables w₁ to w₃ will cause the values of the risk expression dictionary 14a to be strongly reflected in the risk value.

In addition, in a case where participants in a meeting which is held frequently have a deep understanding of the background of each other's utterances, the weight variable w₇ for the value in the communication history DB 14e is increased. Thereby, the value of the risk variable based on expressions that appear frequently or expressions which are closely related to work will be strongly reflected in the risk value.

In addition, in a case where there is a specific relationship such as a one-to-one dialog between a superior and a subordinate, increasing the values of the weight variables w₄ and we will cause the values of the risk variable pᵢ₄ based on the relationship DB 14b and the risk variable pᵢ₅ based on the social attribute DB 14c to be strongly reflected in the risk value.

In addition, in a case where utterance or expression unique to each individual such as a dialog between speakers having specific excellent skills is included, increasing the values of the weight variables w₄ and w₆ will cause the values of the risk variable pᵢ₄ based on the relationship DB 14b and the risk variable pᵢ₅ based on the personal characteristic DB 14d to be strongly reflected in the risk value.

In addition, the weight variables w₁ to w₇ may be dynamically adjusted on the basis of the determination of the quality of consensus building in the immediately preceding dialog or discussion, the result of measurement of satisfaction with the past dialog, the result of measurement of proficiency with respect to the topic of the conversation, and the like.

Using the risk value of each word calculated in Equations (1) to (4), it is also possible to calculate the risk of an entire sentence or a group of expressions made up of multiple words (for example, a phrase or clause). In this case, the average value of the risk values rᵢ calculated for the words included in each sentence may be used as the risk value of the sentence. In addition, the weight average of values obtained by weighting each value of the risk values r₁ to r_{N} based on the degree of risk and importance of the risk expression dictionary 14a or a value set in advance may be calculated and used as the risk value of the sentence. In addition, the sum, product, and the like of the risk values rᵢ can also be used.

The presentation unit 15c presents presentation information generated on the basis of the calculated risk value to the user. For example, the presentation unit 15c presents the risk value calculated by the calculation unit 15b or presentation information such as a message, a notification sound, and vibration generated on the basis of the risk value to the user through the output unit 12.

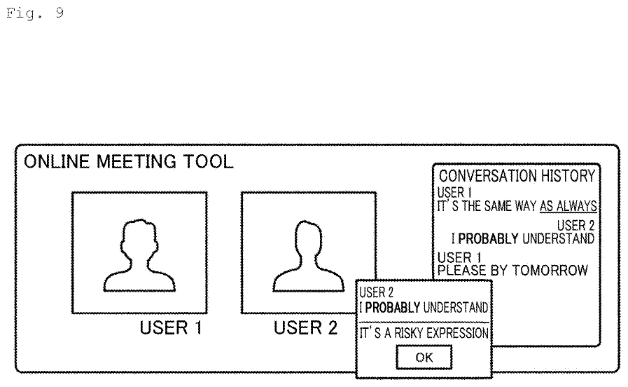

Here, FIG. 9 is a diagram illustrating an example of screen display of presentation processing results. In the example shown in FIG. 9, information on the calculated risk value is presented on the online meeting tool. For example, the presentation unit 15c displays the text of a word with a high risk value in a highlighted manner. For example, the presentation unit 15c changes the color of the text of the word with a high risk value, underlines it, enlarges the font, makes it bold, or highlights the word.

Alternatively, the presentation unit 15c displays text with high risk value in a format that attracts the user's attention such as by displaying it as a pop-up. In addition, the presentation unit 15c may display words with a high risk value by arranging them at positions which are easily visible to the user.

In addition, instead of displaying text or in addition to displaying text, the presentation unit 15c may use audio information or tactile information to present word with a high risk value. For example, the volume of the notification sound of a word with a high risk value is increased, a sound such as an incorrect answer sound which makes it easy to feel the necessity of taking action is used, vibration is increased, or the frequency or pattern of vibration which is easy to pay attention is used.

In addition, the presentation unit 15c may place a CG or image agent on a screen and present words with a high risk value in the format of advice from the agent.

Meanwhile, in the online meeting tool illustrated in FIG. 9, the presentation unit 15c may present the same screen to a user 1 and a user 2, or may present different screens. For example, the presentation unit 15c presents the same screen, so that it is easy for both parties to feel that they are equal, and mutual understanding is promoted. On the other hand, although the degree of promotion of mutual understanding is weakened by the presentation unit 15c presenting different screens, the efficiency of communication is improved by allowing a user with a higher communication skill to engage in the dialog in a mobile manner.

Further, the presentation unit 15c may adjust the presentation method, cancel the presentation itself, or the like. For example, depending on the user's operation or in accordance with the user's characteristics, the presentation unit 15c may make presentation in a different format, such as displaying the highlighted display in a less intense manner, stopping the highlighting, or changing visual information to sound information for a user who is concerned about the highlighted display. In addition, the user characteristics may be reflected in different ways depending on the member composition of the conference participants.

### Presentation Processing

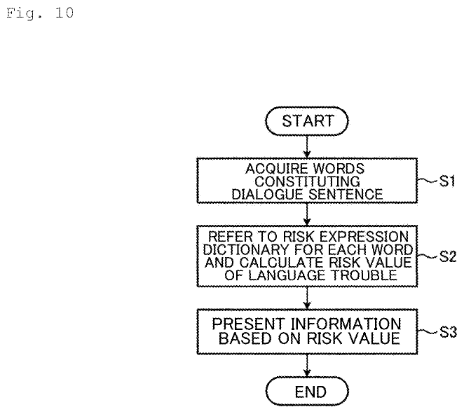

Next, reference will be made to FIG. 10 to describe presentation processing performed by the presentation device 10 according to the present embodiment. FIG. 10 is a flowchart illustrating a presentation processing procedure. The flowchart of FIG. 10 is started, for example, at the timing when the user performs an operation input instructing to start.

First, the acquisition unit 15a acquires words constituting a dialog sentence to be processed (step S1). For example, the acquisition unit 15a accepts an input of a dialog sentence to be processed through the input unit 11 or the communication control unit 13, performs morphological analysis, and extracts words constituting the dialog sentence.

Next, the calculation unit 15b refers to the risk expression dictionary 14a and calculates a risk value indicating the magnitude of the risk of language trouble for the words constituting the input dialog sentence (step S2). For example, the calculation unit 15b calculates the risk value using the product of a plurality of pieces of information having undergone predetermined weighting in the risk expression dictionary 14a. Alternatively, the calculation unit 15b calculates the risk value using the sum of the plurality of pieces of information having undergone predetermined weighting in the risk expression dictionary 14a.

Further, the calculation unit 15b calculates the risk value using any one or more of pieces of information in the relationship DB 14b, the social attribute DB 14c, the personal characteristic DB 14d, or the communication history DB 14e.

In addition, the presentation unit 15c presents the user with presentation information generated on the basis of the calculated risk value (step S3). For example, the presentation unit 15c presents the risk value calculated by the calculation unit 15b to the user through the output unit 12. This completes a series of presentation processing.

### Other Embodiments

In the presentation device 10 of the above-described embodiment, the risk value based on ambiguous expressions is calculated, but there is no limitation thereto. For example, the presentation device 10 can also calculate the risk value of an expression based on a fixed idea instead of a risk value based on an ambiguous expression or in addition to a risk value based on an ambiguous expression. In this case, the calculation unit 15b calculates the risk value using information relating to the risk based on a fixed idea.

For example, as the risk variables pᵢ₁ to pᵢ₃ based on the risk expression dictionary 14a, risk types set from the viewpoint of a fixed idea, and the like may be applied in addition to the degree of risk set from the viewpoint of a fixed idea and ambiguous expressions.

In addition, as the risk variable pᵢ₄ using the relationship DB 14b or the risk variable pᵢ₅ using the social attribute DB 14c, backgrounds common to the speakers, the degree of density of attributes, the degree of overlap, and the like may be applied.

In addition, the speaker's background, attribute, and the like may be applied as the risk variable pᵢ₆ using the personal characteristic DB 14d.

Specifically, for example, in a case where the degree of overlap of backgrounds common to the speakers is small, the values of the risk variable pᵢ₄ and the risk variable pᵢ₆ are set to be large, assuming that there is a high possibility that language interpretations between the speakers will differ. In addition, the speaker's background such as sex and age, and the party's background in the past trouble cases are compared with each other, and the risk variable pᵢ₆ is set on the basis of the risk values in the past trouble cases. This makes it possible for the calculation unit 15b to calculate a risk value based on a fixed idea.

### Effects

Hereinbefore, as described above, in the presentation device 10 of the present embodiment, the storage unit 14 stores the risk expression dictionary 14a which is information relating to the risk of language trouble for each word constituting a dialog sentence. The calculation unit 15b refers to the risk expression dictionary 14a and calculates a risk value indicating the magnitude of risk of each word constituting the input dialog sentence.

Specifically, the risk expression dictionary 14a stores information relating to the risk of any one or more of the part of speech of each word, the number of meanings indicated by each word, or the ambiguity of the meaning indicated by each word.

In addition, the calculation unit 15b calculates a risk value using the product of information relating to a plurality of risks having undergone predetermined weighting.

Alternatively, the calculation unit 15b calculates the risk value using the sum of information relating to a plurality of risks having undergone predetermined weighting.

This makes it possible for the presentation device 10 to quantitatively analyze the risk implied by used expressions in communication through language.

In addition, the calculation unit 15b further calculates the risk value using any one or more of the relationship DB 14b including information relating to the relationship between speakers, the social attribute DB 14c including information indicating the social attributes of speakers and interlocutors, the personal characteristic DB 14d including information indicating the characteristics of the speaker regarding the utterance, or the communication history DB 14e including the dialog history. This makes it possible for the presentation device 10 to calculate a higher-accuracy risk value.

In addition, the calculation unit 15b calculates a risk value using information relating to risk based on a fixed idea. This also makes it possible to calculate a higher-accuracy risk value.

### Program

It is also possible to create a program in which processing executed by the presentation device 10 according to the above-described embodiment is written in a computer-executable language. As an embodiment, the presentation device 10 can be implemented by installing a presentation program for executing the above presentation processing on a desired computer as package software or online software. For example, by causing an information processing device to execute the above-described presentation program, the information processing device can function as the presentation device 10. The information processing device referred to here include a desktop or laptop personal computer. In addition, information processing devices include mobile communication terminals such as smartphones, mobile phones, and a personal handyphone system (PHS), as well as slate terminals such as a personal digital assistant (PDA). In addition, the functions of the presentation device 10 may be implemented in a cloud server.

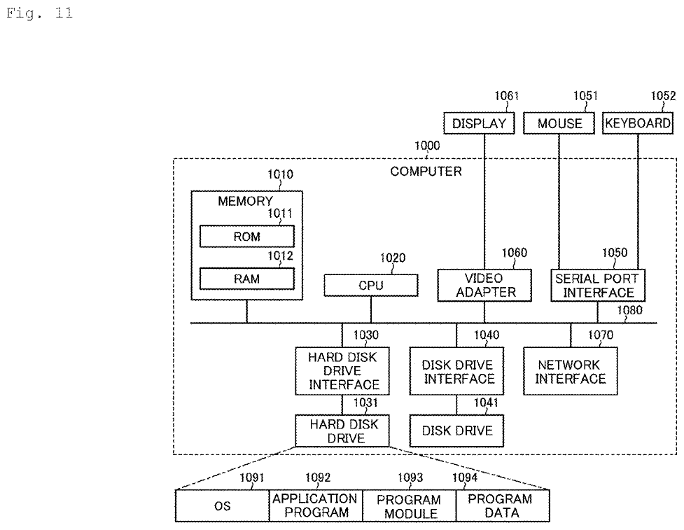

FIG. 11 is a diagram illustrating an example of a computer that executes a presentation program. A computer 1000 has, for example, a memory 1010, a CPU 1020, a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a RAM 1012. The ROM 1011 stores, for example, a boot program, such as a basic input output system (BIOS). The hard disk drive interface 1030 is connected to a hard disk drive 1031.

The disk drive interface 1040 is connected to the disk drive 1041. A removable storage medium such as a magnetic disk or an optical disc is inserted into the disk drive 1041. For example, a mouse 1051 and a keyboard 1052 are connected to the serial port interface 1050. For example, a display 1061 is connected to the video adapter 1060.

Here, the hard disk drive 1031 stores, for example, an OS 1091, an application program 1092, a program module 1093, and program data 1094. Each of the pieces of information described in the above embodiment is stored in, for example, the hard disk drive 1031 or the memory 1010.

In addition, the presentation program is stored in the hard disk drive 1031, for example, as the program module 1093 in which commands to be executed by the computer 1000 are written. Specifically, the program module 1093 in which each process executed by the presentation device 10 described in the above-described embodiment is described is stored in the hard disk drive 1031.

In addition, the data used for information processing based on the presentation program is stored as the program data 1094 in, for example, the hard disk drive 1031. Thereafter, the CPU 1020 reads the program module 1093 and the program data 1094 stored in the hard disk drive 1031 into the RAM 1012 when necessary, and executes each of the procedures described above.

Meanwhile, the program module 1093 and the program data 1094 related to the presentation program are not limited to a case where they are stored in the hard disk drive 1031, and may be stored in, for example, a removable storage medium and read out by the CPU 1020 through the disk drive 1041 or the like. Alternatively, the program module 1093 and the program data 1094 related to the presentation program may be stored in another computer connected through a network such as a LAN or a wide area network (WAN), and read out by the CPU 1020 through the network interface 1070.

Although embodiments to which the invention made by the present inventor is applied have been described above, the present invention is not limited to the description and drawings which form part of the disclosure of the present invention according to the present embodiments. That is to say, all other embodiments, examples, operational techniques, and the like made by those skilled in the art on the basis of this embodiment are included in the scope of the present invention.

### REFERENCE SIGNS LIST

10 Presentation device
11 Input unit
12 Output unit
13 Communication control unit
14 Storage unit
14a Risk expression dictionary
14b Relationship DB
14c Social attribute DB
14d Personal characteristic DB
14e Communication history DB
15 Control unit
15a Acquisition unit
15b Calculation unit
15c Presentation unit

1. A presentation device comprising:
a storage configured to store information relating to a risk of language trouble for each word constituting a dialog sentence; and
to refer to the storage and calculate a risk value indicating a magnitude of the risk of each word constituting the input dialog sentence.

2. The presentation device according to claim 1, wherein the storage stores information relating to the risk of any one or more of a part of speech of each word, the number of meanings indicated by each word, or ambiguity of meaning indicated by each word.

3. The presentation device according to claim 1, wherein the risk value is calculated using a product of information relating to a plurality of the risks having undergone predetermined weighting.

4. The presentation device according to claim 1, wherein the risk value is calculated using a sum of information relating to a plurality of the risks having undergone predetermined weighting.

5. The presentation device according to claim 1, wherein the risk value is further calculated using any one or more of information relating to a relationship between speakers, information indicating social attributes of a speaker and an interlocutor, information indicating characteristics of a speaker regarding an utterance, or a dialog history.

6. The presentation device according to claim 1, wherein the risk value is calculated using information relating to the risk based on a fixed idea.

7. A presentation method executed by a presentation device, wherein the presentation device has a storage configured to store information relating to a risk of language trouble for each word constituting a dialog sentence, and
the method comprises referring to the storage and calculating a risk value indicating a magnitude of the risk of each word constituting the input dialog sentence.

8. (canceled)

9. The presentation method according to claim 7, wherein the storage stores information relating to the risk of any one or more of a part of speech of each word, the number of meanings indicated by each word, or ambiguity of meaning indicated by each word.

10. The presentation method according to claim 7, wherein the risk value is calculated using a product of information relating to a plurality of the risks having undergone predetermined weighting.

11. The presentation method according to claim 7, wherein the risk value is calculated using a sum of information relating to a plurality of the risks having undergone predetermined weighting.

12. The presentation method according to claim 7, wherein the risk value is further calculated using any one or more of information relating to a relationship between speakers, information indicating social attributes of a speaker and an interlocutor, information indicating characteristics of a speaker regarding an utterance, or a dialog history.

13. The presentation method according to claim 7, wherein the risk value is calculated using information relating to the risk based on a fixed idea.

14. A computer-readable non-transitory recording medium storing computer-executable program instructions that when executed by a processor cause a computer to execute a presentation method comprising:
a storage configured to store information relating to a risk of language trouble for each word constituting a dialog sentence, and
referring to the storage and calculating a risk value indicating a magnitude of the risk of each word constituting the input dialog sentence.

15. The computer-readable non-transitory recording medium according to claim 14, wherein the storage stores information relating to the risk of any one or more of a part of speech of each word, the number of meanings indicated by each word, or ambiguity of meaning indicated by each word.

16. The computer-readable non-transitory recording medium according to claim 14, wherein the risk value is calculated using a product of information relating to a plurality of the risks having undergone predetermined weighting.

17. The computer-readable non-transitory recording medium according to claim 14, wherein the risk value is calculated using a sum of information relating to a plurality of the risks having undergone predetermined weighting.

18. The computer-readable non-transitory recording medium according to claim 14, wherein the risk value is further calculated using any one or more of information relating to a relationship between speakers, information indicating social attributes of a speaker and an interlocutor, information indicating characteristics of a speaker regarding an utterance, or a dialog history.

19. The computer-readable non-transitory recording medium according to claim 14, wherein the risk value is calculated using information relating to the risk based on a fixed idea.

20. The presentation device according to claim 1, wherein when a degree of overlap of common background is low, a plurality of risk variables is set based on previous risk value.

21. The presentation device according to claim 1, wherein the dialog sentence is processed using morphological analysis to extract the each word consisting the dialogue sentence.
